(19) United States
(12) Patent Application Publication
(10) Pub. No.: US 2026/0174286 A1
(43) Pub. Date: Jun. 25, 2026

(54) ICED BEVERAGE BLENDING CUP DEVICES, SYSTEMS, AND METHODS

(71) Applicant: BOTRISTA, INC., San Francisco, CA (US)

(72) Inventors: Wu-Chou KUO, San Francisco, CA (US); Yu-Wei CHEN, New Taipei City (TW)

(21) Appl. No.: 19/000,288

(22) Filed: Dec. 23, 2024

Related U.S. Application Data
(60) Provisional application No. 63/661,669, filed on Jun. 19, 2024.

(51) Int. Cl. A47J 43/07; A47J 36/06

(52) U.S. Cl. CPC A47J 43/0722; A47J 36/06; A47J 43/0727

(57) ABSTRACT

Methods, systems, and devices for blending beverage ingredients together with ice, such as producing a smoothie or other iced blended beverage, are disclosed. For example, the disclosed technology provides a system for blending liquid and ice within a blender cup chamber. The blender cup includes a lid integrated with a funnel for directing ingredients into the chamber, and a lid base with indentations around the edge of the base for pouring blended beverage from the blender cup into, for example, one or more serving cups. A blending component is integrated with the chamber for blending ice and beverage ingredients in the chamber. The system includes a processor and memory, which executes instructions for beverage ingredient dispensing, blending, and cleaning operations.

### TECHNICAL FIELD

The present technology is generally directed to iced beverage blending systems and more specifically to blender cups.

### BACKGROUND

Freshly made beverages are typically more desirable to consumers than factory-produced, canned, or bottled beverages. For example, freshly made beverages can have superior taste, freshness, and/or customizability in the ingredients used in the beverage. Accordingly, restaurants, cafés, coffee shops, and/or other beverage vendors prefer to offer a menu of freshly made beverages. The fresh preparation, however, typically requires the time and attention of vendor personnel, which can slow down order production, causing customer dissatisfaction, reducing the volume of orders vendors can produce, and/or increasing the costs per order. Preparing fresh beverages also requires increased attention to avoid fresh ingredients surpassing their shelf-life and to avoid spoilage and/or other degradation of the beverage ingredients. To meet these challenges, vendors have increasingly automated portions, or all, of the production of beverages.

### BRIEF DESCRIPTION OF THE DRAWINGS

FIG. 1 is a schematic block diagram of a beverage system configured in accordance with embodiments of the present technology.

FIG. 2A illustrates a blender cup device in accordance with some embodiments of the present technology.

FIGS. 2B and 2C illustrate an iced blender cup system for use with the blender cup device of FIG. 2A in accordance with some embodiments of the present technology.

FIG. 3A is a perspective view of a blender cup device in accordance with some embodiments of the present technology.

FIG. 3B is a cross-sectional schematic from line 3B-3B of the blender cup device of FIG. 3A.

FIG. 4A is a perspective view of a blender cup device in accordance with some embodiments of the present technology.

FIG. 4B is a cross-sectional schematic from line 4B-4B of the blender cup device of FIG. 4A.

FIG. 5A is a perspective view of a blender cup device in accordance with some embodiments of the present technology.

FIG. 5B is a cross-sectional schematic from line 5B-5B of the blender cup device of FIG. 5A.

FIG. 6A is a perspective view of a blender cup lid in accordance with some embodiments of the present technology.

FIG. 6B is a cross-sectional schematic from line 6B-6B of the blender cup lid of FIG. 6A.

FIG. 7A is a perspective view of a blender cup lid in accordance with some embodiments of the present technology.

FIG. 7B is a cross-sectional schematic from line 7B-7B of the blender cup lid of FIG. 7A.

FIG. 8 is a flowchart illustrating a method of preparing an iced blended beverage in accordance with some embodiments of the present technology.

FIG. 9 is a block diagram illustrating an overview of devices on which some implementations can operate.

FIG. 10 is a block diagram illustrating an overview of an environment in which some implementations can operate.

FIG. 11 is a block diagram illustrating components which, in some implementations, can be used in a system employing the disclosed document.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

### Overview

The present technology provides iced blending cup devices, systems, and methods for efficiently blending beverage ingredients together with ice, such as producing a smoothie or other blended beverage. For example, the technology described herein provides a versatile and efficient system configured to blend liquid and ice, and optionally dry ingredients, within a blender cup (also referred to as a blending cup) chamber. The system includes a lid integrated with a funnel for directing ingredients into the chamber. In some embodiments, the lid includes a lid base with narrow/small indentations (e.g., recesses, cut-outs, openings, etc.) around the edge of the base for pouring blended beverage from the blender cup into, for example, one or more serving cups. A blending component is integrated with the chamber and blends ice and beverage ingredients contained in the chamber. The device is controlled by a processor and memory, which execute instructions for beverage ingredient dispensing, blending, and cleaning operations. The disclosed technology provides various configurations for the funnel and chamber shapes, as well as different shapes for the indentations in the base of the lid, providing a range of functional options for the user.

The disclosed technology assists in automating the process of preparing beverages that involve blending ice with other ingredients. Traditional blender cups and lids require multiple manual steps, including measuring and adding ice and liquid ingredients, sealing the cup, blending, and cleaning, with multiple steps requiring removal and replacement of the blender cup lid. This process is time-consuming and can be prone to human error. The disclosed technology incorporates a funnel into the lid, which simplifies the automated addition of ingredients into the blender cup. This significantly reduces the number of manual steps required by the human operator, which can save a significant amount of time, especially in a busy store environment where multiple beverages are prepared throughout the day. Additionally, the lid features one or more open corners, which facilitate pouring the blended beverage from the cup without having to remove the lid, further reducing the time needed to prepare a large number of beverages. The open corners also simplify cleaning. For example, the open corners can allow dirty water to drain out during rinsing without the need to remove the lid, speeding up the cleaning process and preparing the cup to be used for additional beverages more quickly.

In some embodiments, the present technology provides a system comprising a blender cup device that includes a chamber with an upper section and a lower section. The chamber is configured to receive and hold a volume of at least one liquid beverage ingredient along with a measurement of ice. As used herein, a “measurement” can include an imprecise and/or inexact amount or portion of a substance (e.g., ice). In some embodiments, a “measurement” refers to a precisely determined amount or portion of a substance. The cup device also includes a lid equipped with a funnel that has an inlet and an outlet. The funnel directs liquid beverage ingredient received at the inlet into the chamber via the outlet, ensuring efficient transfer of ingredient without spillage. The lid further includes a base shaped to complement the rim of the upper section of the chamber, such that at least a partial seal is formed between the segment of the base in contact with the rim when the lid is coupled to the upper section of the chamber. A blending component integrated with the lower section of the chamber is configured to blend ice contained in the chamber with beverage ingredients contained in the chamber, ensuring a consistent iced beverage. The system also includes a processor and a memory. The memory contains instructions that, when executed by the processor, enable the cup device to receive the volume of at least one liquid beverage ingredient via the funnel and blend it with the measurement of ice using the blending component.

In some embodiments, the base of the lid includes one or more indentations extending inward from the edges of the base toward a central point of the base. Each indentation at least partially defines an opening of the cup device when the lid is coupled to the upper section. The indentations and outlet of the funnel are configured to be sufficiently narrow so that ice and/or beverage ingredients are mitigated and/or prevented from exiting the blender cup during blending. In some embodiments, the indentations are omitted from the base, further mitigating and/or preventing ice and/or beverage ingredients from exiting the blender cup during blending.

In some embodiments, a rim of the inlet of the funnel includes one or more narrow openings formed around the edge of the rim. These openings are configured to drain cleaning water and/or cleaning fluid from the chamber without needing to remove the lid.

Once blended, the mixture contained in the blender cup is poured (e.g., into an individual serving cup). In some embodiments, the mixture is poured via the openings that are at least partially defined by the indentations of the base. Thus, in some embodiments, the lid remains coupled to the chamber throughout the addition of beverage ingredient, blending of ingredients, and pouring of the mixture, effectively automating multiple conventional blending steps and saving significant time and effort (particularly when aggregated over multiple blended iced beverages). That is, while conventional methods of blending an iced drink may require multiple steps where a user removes and replaces the lid of a blender cup to deliver ice, beverage ingredients, and to pour into a serving cup, the present technology reduces the number of times a user has to remove and replace the lid. Furthermore, in some embodiments, a cleaning fluid (e.g., water, soap solution, etc.) is applied to the chamber via the funnel and the dirty cleaning fluid is drained via the same indentations used to pour the mixed beverage. This further reduces the number of times/interactions a user has to engage with the blender cup, saving additional time and effort.

In some embodiments, the outlet of the funnel is positioned below the rim of the chamber, while the inlet of the funnel is positioned above the rim when the lid is coupled to the upper section. This configuration is adapted for certain configurations of beverage ingredient dispenser, ensuring that beverage ingredient is dispensed into the chamber efficiently and minimizing the risk of spillage. In some embodiments, both the outlet and the inlet of the funnel are positioned above the rim of the chamber when the lid is coupled to the upper section. This configuration is likewise adapted for certain configurations of beverage ingredient dispenser, and minimizes displacement of beverage ingredient, ice, and/or mixed beverage in the chamber. In some embodiments, the outlet of the funnel is positioned below the rim of the chamber, and the inlet of the funnel is approximately flush with the plane of the rim when the lid is coupled to the upper section. This configuration provides an alternative method for directing the liquid beverage ingredient into the chamber, ensuring efficient flow and minimal spillage.

In some embodiments, the rim of the chamber and the base of the lid are approximately quadrilateral in shape (e.g., square, rectangular, rhomboidal, etc.). That is, the base of the lid is shaped to generally match the shape of the rim (e.g., a quadrilateral), with the exception that one or more of the indentations that are formed on and/or in the edge of the base cause the shape of the base to deviate from the shape of the rim where the indentations are located. For example, in some embodiments, the indentations in the base are positioned near the corners of the rim, such that the shape of the base generally matches the shape of the rim with the exception of the corners of the base, through which the contents of the chamber (e.g., blended beverage, cleaning fluid, etc.) are poured/drained out of the chamber. In some embodiments the rim of the chamber and the base of the lid are approximately round in shape. That is, in some embodiments, the rim is round in shape, and the base is generally round with the exception that the perimeter of the base deviates from a round shape where the indentations are formed on and/or in the edge of the base. In some embodiments, the indentations are evenly distributed around the edge of the base, such that the shape of the base generally matches (e.g., is complementary to) the shape of the rim with the exception of one or more evenly-spaced indentations.

In some embodiments, the indentations in the base are semi-circular in shape. In some embodiments, the indentations in the base are angular in shape. In some embodiments, the indentations in the base are a mixture of shapes (e.g., one or more are semi-circular and one or more are angular).

In some embodiments, the functionality of the chamber is extended to also receive a measurement of dry beverage ingredient. Further, the system memory includes additional instructions that enable the cup device to blend dry beverage ingredients with the liquid beverage ingredients and ice. This allows for the creation of a wider variety of iced beverages, including those that require dry ingredients such as powdered flavors or supplements.

In some embodiments, the funnel of the lid is also configured to direct a volume of cleaning fluid (e.g., water, soap/water solution, etc.) into the chamber. Further, the system memory includes instructions that enable the cup device to receive the cleaning fluid via the funnel, and to clean the chamber with the cleaning fluid (producing, e.g., waste fluid or dirty water/fluid) while the lid remains coupled to the chamber. In some embodiments, the waste fluid/water is drained/poured out of the chamber via the indentations in the base. This further reduces the number of interactions/times a user has to remove/replace the lid to produce one or more blended ice beverages, since the lid remains coupled through the blending and cleaning process. Thus, further time and effort is saved compared to conventional iced blending systems and methods.

### A. Embodiments of Beverage Systems

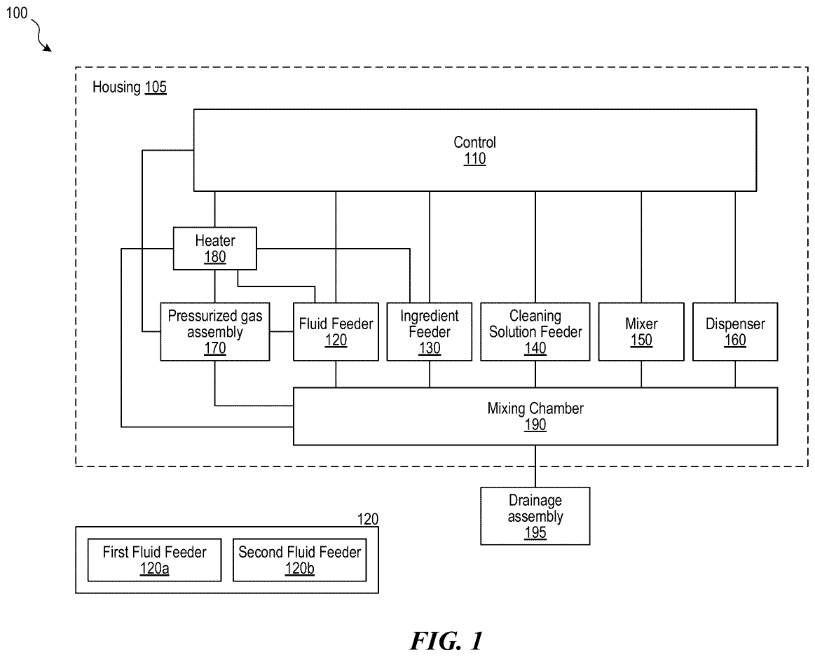

FIG. 1 is a schematic block diagram of a beverage system 100 configured in accordance with embodiments of the present technology. The system 100 can include a control 110, a fluid feeder 120, an ingredient feeder 130, a cleaning solution feeder 140, a mixer 150, a dispenser 160, a pressurized gas assembly 170, a heater 180, and a mixing chamber 190. In some embodiments, the system 100 may include a drainage assembly 195. At least some of these components 110-195 may be accommodated within a housing 105. As discussed further herein, the system 100 can be operated to prepare a beverage. In FIG. 1, some of the components are linked together by lines, indicating that those components can be operably coupled to one another. However, in some embodiments, those components may not be operably coupled as such.

The control 110 may be configured to interface with a user and/or coordinate the operation of the system 100. The control 110 may include one or more hardware and software components for controlling operation of the system 100. For example, the control 110 can include one or more processors (e.g., central processing unit(s) (CPU(s)), graphics processing unit(s) (GPU(s)), holographic processing unit(s) (HPU(s)), etc.) and memory (e.g., volatile storage, non-volatile storage) for storing instructions to be executed by the one or more processors. The control 110 may include or be in the form of one or more controllers, one or more controller circuits, or the like, or a combination thereof. Examples of controllers may include a microcontroller, a programmable logic controller (PLC), a digital signal controller (DSC), a motor controller, a temperature controller, a valve controller, or the like, or a combination thereof. In some embodiments, the control 110 may include a control circuit formed by a plurality of controllers.

The control 110 may include or function as a central command unit, interfacing with a user through input signals. The control 110 may interpret user input and translate it into actionable instructions for the system components. For instance, when a user selects a beverage option, the control 110 may process this input and send appropriate signals to the fluid feeder 120, the ingredient feeder 130, the mixer 150, the dispenser 160, causing the fluid feeder 120 and the ingredient feeder 130 to discharge appropriate amounts of fluid and one or more target ingredients (also referred to as beverage ingredients or liquid beverage ingredients), causing the mixer 150 to mix them in the mixing chamber 190, and causing the dispenser 160 to allow the resulting mixture to be dispensed from the mixing chamber 190 to a cup (e.g., a blender cup for subsequent blending/mixing, an individual serving cup, etc.), thereby producing the beverage of choice automatically.

The control 110 can operate autonomously by utilizing embedded algorithms. Exemplary algorithms can include predetermined beverage production schedules to warm-up and peak/off-peak time management, beverage recipes (including, e.g., respective amounts of a fluid and one or more target ingredients, dispensing parameters, temperature, or the like, or a combination thereof), predictive algorithms to forecast demand based on historical data, cleaning schedules and/or protocols to maintain hygiene standards, or the like, or a combination thereof.

The signals generated by the controller or control circuit may be tailored for specific actions within the system 100. For instance:

Valve Control: The control 110 can generate signals to open or close a controllable valve regulating the flow of water or other fluids through the system 100. This may allow the right amount of fluid to be dispensed at the right time.

Actuator Control: Signals can be generated to control actuators or motors responsible for moving components of the system 100. This may involve driving the mixer 150 to perform mixing, moving the dispenser 160 to allow or block dispensing from the mixing chamber 190, etc.

Pump Operation: The control 110 can modulate the operation of pumps to adjust the flow rate and/or pressure of a fluid, a gas, a mixture, etc., maintaining consistency and quality in beverage production, cleaning, etc.

Temperature Regulation: The control 110 can manage heaters or coolers within the system 100, sending signals to adjust the temperature of a fluid to a desired level, achieving that beverages are served at a desired temperature.

The fluid feeder 120 may be configured to hold and/or discharge a fluid. The fluid may be used to make a beverage or clean at least a portion of the system 100. In some embodiments, the fluid may be water, e.g., tap water, filter water, etc. The fluid feeder 120 may include a fluid channel where a fluid is discharged into the mixing chamber 190. The fluid channel may be coupled to a fluid supply source. The fluid supply source may include a tank, a container, or another storage component for storing the fluid. The fluid supply source may be part of the fluid feeder 120. For example, the fluid supply source may include a fluid tank positioned within or outside the housing 105. The fluid supply source may be an external source (e.g., tap water) connected to the fluid feeder 120 via a tube. The fluid supply source may be connected to the fluid channel via a tube. The fluid feeder 120 may include a pump and/or a valve (e.g., a metering valve, a solenoid valve, or another type of controllable valve) to facilitate delivering the fluid from the fluid supply source to the fluid channel for discharging into the mixing chamber 190. At least one of the pump or the valves may be controlled, based on signals (e.g., signals from the control 110), to regulate when and/or how much fluid is fed to the fluid channel, or to the mixing chamber 190 via the fluid channel. A fluid may flow in only one direction, from the fluid supply source toward the mixing chamber 190, not in the reverse direction.

In some embodiments, as illustrated in panel I of FIG. 1, the system 100 may include multiple (e.g., two or more) fluid feeders 120 configured to feed different fluids to one or more other components of the system 100, e.g., the mixing chamber 190. At least two of the multiple fluid feeders 120 may be configured (substantially) the same. For example, each fluid feeder 120 may include or be connected to a fluid supply source, a pump, and/or a valve. The pump may be controlled by a controller or control circuit. The valve may be controlled by a controller or control circuit. For example, the pump and the valve of a fluid feeder may be controlled by a first controller and a second controller, respectively; the first controller and the second controller may be integrated onto a same control circuit. The pump and/or valve of a fluid feeder may be configured based on one or more properties of the fluid including, e.g., density, viscosity, or the like, or a combination thereof. In some embodiments, at least two of the multiple fluid feeders may be connected to the same fluid channel for discharging a respective fluid into the mixing chamber 190. In some embodiments, a first fluid feeder may be connected to the fluid channel for discharging a first fluid into the mixing chamber 190, while a second fluid feeder may be configured to discharge a second fluid directly into the mixing chamber 190.

The ingredient feeder 130 may be configured to hold and/or discharge one or more ingredients. The ingredient(s) may be used to make a beverage using the system 100. The ingredient feeder 130 may include a tank, a container, or one or more other storage components for storing one or more ingredients to be used for producing a beverage. Example ingredients include syrups (e.g., caramel syrup, mocha syrup), whipped cream, dairy and non-dairy milk alternatives (e.g., whole milk, skim milk, half-and-half, heavy cream, soy milk, almond milk, coconut milk, etc.), fruit purees or juices (e.g., mango puree/juice, strawberry puree/juice, peach puree/juice, pineapple puree/juice, apple puree/juice, orange puree/juice, etc.), and/or other fluid-based ingredients. A fruit juice may include pulp or not. In some embodiments, the ingredient feeder 130 may include multiple, isolated compartments for separately storing multiple ingredients. The ingredient feeder 130 may further include one or more ingredient nozzles for discharging one or more ingredients into the mixing chamber 190. An ingredient nozzle may be coupled to an ingredient container via a tube. The ingredient feeder 130 may include a pump and/or a valve to facilitate delivering an ingredient from an ingredient container to the ingredient nozzle for discharging into the mixing chamber 190. At least one of the pump and/or the valve may be controlled, based on signals (e.g., signals from the control 110), to regulate when and/or how much an ingredient is fed to the mixing chamber 190 via a corresponding ingredient nozzle. The ingredient feeder 130 may include a nozzle plate where one or more ingredient nozzles are supported. The nozzle plate may be supported on the mixing chamber 190. An ingredient may flow in only one direction, from an ingredient source toward the mixing chamber 190, not in the reverse direction. For example, an ingredient valve may be a one-way valve. Additional description may be found elsewhere in the present document.

The cleaning solution feeder 140 may be configured to hold and/or discharge one or more cleaning solutions. The cleaning solution(s) may be used to clean at least a portion of the system 100. The cleaning solution feeder 140 may include a tank, a container, or one or more other storage components for storing one or more cleaning solutions to be used for cleaning at least a portion of the system 100, e.g., the mixer 150, the dispenser 160, the mixing chamber 190, etc. Example cleaning solutions may include a detergent, a degreaser, a sanitizer, or a disinfectant, etc. In some embodiments, the cleaning solution feeder 140 may include or have access to multiple cleaning solutions such that the system 100 may perform a cleaning process using one or more cleaning solutions. For example, a cleaning process may include multiple steps, each using a different cleaning solution. Merely by way of illustration, a cleaning process may include a first step using a detergent (either alone or mixed with a fluid, e.g., water), a second step using a degreaser (either alone or mixed with a fluid, e.g., water), a third step using disinfectant (either alone or mixed with a fluid, e.g., water), and a fourth step of blow drying.

Cleaning solutions may be guided through various portions of the system 100 for cleaning purposes. In some embodiments, a cleaning solution may flow through at least a portion of the fluid feeder 120 and then to the mixing chamber 190. For example, a cleaning solution may be mixed with the fluid in the fluid feeder 120 before being discharged into the mixing chamber 190. As another example, a cleaning solution may flow through at least a portion of the fluid feeder 120 and into the mixing chamber 190 without being mixed with the fluid. In some embodiments, a cleaning solution may be discharged into the mixing chamber 190 directly without going through the fluid feeder 120. In some embodiments, cleaning solution may be discharged into the mixing chamber 190 and subsequently dispensed into a cup (e.g., a blender cup, an individual user cup, etc.) in order to clean the cup. The cleaning solution feeder 140 may include or be connected to one or more cleaning solution nozzles for discharging one or more cleaning solutions into the mixing chamber 190. A cleaning solution nozzle may be coupled to a cleaning solution container via a tube. The cleaning solution feeder 140 may include a pump and/or a valve to facilitate delivering a cleaning solution from a cleaning solution container to the cleaning solution nozzle for discharging into the mixing chamber 190. At least one of the pump and/or the valve may be controlled, based on signals (e.g., signals from the control 110), to regulate when and/or how much a cleaning solution is fed to the mixing chamber 190. A cleaning solution may flow in only one direction, from a cleaning solution source toward the mixing chamber 190, not in the reverse direction. For example, a cleaning solution valve may be a one-way valve.

The mixing chamber 190 may be configured to receive content from one or multiple sources. The mixing chamber 190 may receive content from one or more sources including the fluid feeder 120, the ingredient feeder 130, and the cleaning solution feeder 140. The mixing chamber 190 may be positioned along a vertical direction (e.g., along a rotation axis Z of the mixing chamber 190) below, at substantially the same level as, or above at least a portion of the fluid feeder 120, the ingredient feeder 130, and/or the cleaning solution feeder 140. For example, the fluid feeder 120 may include or be coupled to a fluid source to receive a fluid; the mixing chamber 190 may be positioned below at least a portion of the fluid source (along the vertical direction, allowing fluid to flow from the fluid source into the mixing chamber 190 driven at least in part by gravity). As another example, the mixing chamber 190 may be positioned substantially at the same level as or above at least a portion of the fluid source along the vertical direction, allowing fluid to flow from the fluid source into the mixing chamber 190 driven at least in part by a pump.

The mixing chamber 190 may include a dispensing opening through which the content may be dispensed, e.g., to a user's cup, a blender/blending cup, a drainage assembly, a drainage container, etc. The mixing chamber 190 may provide a space where the content can be mixed before being dispensed. For example, the mixing chamber 190 may receive content including the fluid from the fluid feeder 120 and one or more ingredients from the ingredient feeder 130, the content may be mixed in the mixing chamber 190 using the mixer 150 to form a mixture, and the mixture may be dispensed from the mixing chamber 190 via the dispensing opening. As another example, the mixing chamber 190 may receive content (e.g., the fluid) and allow the content to be dispensed from the mixing chamber 190 without being mixed with another substance (e.g., a different fluid, a cleaning solution, or an ingredient). The mixing chamber 190 may include one or more food-grade materials. Suitable materials for the mixing chamber 190 may include stainless steel, silicone, plastic, or rubber, depending on the durability and compatibility with the content of the mixing chamber 190.

The mixer 150 may be configured to mix content in the mixing chamber 190. The content may include, e.g., a fluid (e.g., the fluid from the fluid feeder 120), one or more other ingredients (e.g., one or more ingredients from the ingredient feeder 130), one or more cleaning solutions (e.g., one or more ingredients from the cleaning solution feeder 140). In use, the mixer 150 may be at least partially immersed in the content (including a liquid medium). For example, the mixer 150 may mix a fluid (e.g., from the fluid feeder 120) with one or more ingredients in the mixing chamber 190 as part of the process of producing a beverage of choice. As another example, the mixer 150 may mix a fluid (e.g., from the fluid feeder 120) with one or more cleaning solutions in the mixing chamber 190 as part of a cleaning process. The mixer 150 may include a mechanical stirrer, a vibration stirrer, an ultrasonic transducer, or a combination thereof. For example, the mixer 150 may include a mechanical stirrer coupled to a rotating motor, thereby performing mixing by rotating. As another example, the mixer 150 may include a transducer coupled to a pulse generator, thereby performing mixing by ultrasonic vibration. The rotating motor or the pulse generator may be controlled based on signals from, e.g., the control 110. In some embodiments, the mixer 150 may be detachable from its actuator or transducer for cleaning or replacement. In some embodiments, the coupling between the mixer 150 and the actuator may be not detachable. For example, the system 100 is configured with automated cleaning features and it is unnecessary to remove the mixer 150 for cleaning. The mixer 150 may include one or more food-grade materials. Suitable materials for the mixer 150 may include including stainless steel, aluminum, food-grade plastic, silicone, fiberglass, rubber, or the like, or an alloy, or a combination thereof, depending on one or more factors including safety, durability, weight, compatibility with the content of the mixing chamber 190, etc.

The dispenser 160 may be configured to control dispensing from the mixing chamber 190 via the dispensing opening. In some embodiments, the dispenser 160 may be moveable to adjust the extent to which the dispensing opening is available for dispensing. The dispenser 160 may be coupled to an actuator controlled based on signals from, e.g., the control 110. Merely by way of example, the dispenser 160 may partially block or completely block the dispensing opening, thereby reducing or eliminating the flow exiting the mixing chamber 190 through the dispensing opening. The dispenser 160 may include a plug having a shape and size complementary to the dispensing opening of the mixing chamber 190. The dispenser 160 may include one or more food-grade materials. Suitable materials for the dispenser 160 may include a material including stainless steel, aluminum, food-grade plastic, silicone, fiberglass, rubber, or the like, or an alloy, or a combination thereof, depending on one or more factors including safety, durability, weight, compatibility with the content of the mixing chamber 190, etc.

The pressurized gas assembly 170 may be configured to provide pressurized gas. In some embodiments, the gas may include air. The pressurized gas assembly 170 may include a gas pump. The pressurized gas assembly 170 may provide pressurized gas into one or more portions of the system 100. For example, the pressurized gas assembly 170 may provide pressurized gas into the mixing chamber 190 to facilitate mixing of ingredients by performing aeration mixing. As another example, the pressurized gas assembly 170 may provide pressurized gas into the mixing chamber 190 to facilitate dispensing of content (e.g., a mixture) from the mixing chamber 190 into, e.g., a blender cup. As a further example, the pressurized gas assembly 170 may supply pressurized gas to the fluid channel or spray rim. This pressurized gas can either pressurize a fluid to enhance cleaning performance or, without mixing with water, blow dry at least a portion of the system 100 for cleaning and/or storage purposes. The operation of the pressurized gas assembly 170 (e.g., a gas pump of the pressurized gas assembly 170) may be controlled based on signals from, e.g., the control 110.

In some embodiments, the pressurized gas assembly 170 may serve as a vacuum assembly configured to remove air from the mixing chamber 190. For example, through an opening on the nozzle plate, a gas pump in the pressurized gas assembly 170 may extract air from the mixing chamber 190 before ingredient(s) and/or fluid are added or mixed in the mixing chamber 190. This air extraction process may continue for a certain period (e.g., 10, 20, or 30 seconds) and/or until the air pressure in the mixing chamber 190 reaches a specified level. Reducing or minimizing air in the mixing chamber 190 during the mixing operation may slow down ingredient oxidation and/or reduce foam generation (e.g., when mixing a dairy product), thereby improving the quality of the produced beverage and/or simplifying the cleaning process. For instance, reducing foam during the blending process helps prevent dairy products from adhering to hard-to-clean corners, making the system 100 easier to clean.

The heater 180 may be configured to heat content and/or components of the system 100. In some embodiments, the heater 180 may be configured to heat a fluid, an ingredient, and/or a gas to facilitate the production of a warm or hot beverage of choice, and/or to aid in the cleaning of the system. The operation of the heater 180 may be controlled based on signals from, e.g., the control 110.

The drainage assembly 195 may be configured to facilitate drainage within the system 100 including, e.g., drainage of waste liquid generated in a cleaning process, overflow of a portion of a beverage produced, etc. In some embodiments, one or more of other components of the system 100 may drain directly to the drainage assembly 195. Merely by way of example, the fluid feeder 120 may be connected to the drainage assembly 195 via a tube to drain the fluid for one or more purposes including, e.g., cleaning, overflow protection, etc.

In some embodiments, the drainage assembly 195 may be connected to a drainage system, providing several technical benefits that enhance its functionality and operational efficiency. The inclusion of a drainage assembly 195 may allow liquid waste, such as overflow from beverages or used cleaning liquid, to be drained away automatically or with minimal user intervention. This automated drainage capability may ensure that the system 100 remains clean and free of excess liquid, reducing the risk of spillage and maintaining a hygienic environment. The integration of the drainage assembly 195 may simplify the maintenance process by reducing or eliminating the need for manual emptying of waste containers, thereby saving time and labor. Additionally, the continuous drainage of liquid waste may help prevent potential damage or wear to the system components caused by liquid buildup, thus extending the overall lifespan of the system. This feature may be beneficial in high-use settings, where efficient waste management is needed for uninterrupted operation. Moreover, by ensuring that waste liquids are promptly and efficiently removed, the system 100 may maintain optimal performance and reliability, as well as the quality of the beverages produced.

In some embodiments, the system 100 may omit a drainage assembly connected to a drainage system (e.g., a sewage line). Traditional drainage solutions typically need connection to sewage lines, sump pumps, or specialized drainage tanks, which can limit the flexibility of system installation and/or use. By eliminating the need for these drainage infrastructures, the system 100 can be set up in locations without access to such drainage systems, providing greater flexibility in its deployment. This design feature may allow the system 100 to be installed in a wider variety of environments, including remote locations (e.g., at an outdoor event or outdoor seating area of a facility) or temporary sites (e.g., temporarily in different conference rooms or party rooms when needed) where traditional drainage solutions are not feasible. This flexibility may enhance the system's versatility, making it suitable for diverse applications and reducing the constraints associated with conventional drainage solutions. Additionally or alternatively, omitting the drainage assembly may simplify the system's design and may reduce installation and maintenance costs, thereby improving overall operational efficiency and cost-effectiveness. For example, the drainage assembly 195 may include a waste bin to collect small amounts of overflow. The waste bin may be positioned underneath the space where dispensing from the mixing chamber 190 occurs and/or where a user cup is placed. As an illustration, the waste bin may include a container and a cover with features (e.g., slots, perforations) that allow the passage of liquid waste (e.g., beverage overflow). The waste bin may be emptied manually. For example, the waste bin may include a sensor or sensing circuit configured to monitor the level of liquid waste and provide a notification if the level exceeds a threshold. The system 100 may be configured to notify a user that a cleaning process is to be performed and/or requests that the user place a container underneath the mixing chamber 190 or elsewhere to collect used cleaning liquid. A notification may be a visual indicator (e.g., a floating tag that becomes visible to a user when the level exceeds a threshold or when a cleaning process is to be performed). The notification may be an electronic alert sent to the system 100 and/or a user in one or more of various forms including, e.g., text, audio, image, a flashing light, or the like, or a combination of thereof.

In some embodiments, the housing 105 may prevent public access to the components of the system 100 positioned within the housing 105. For example, the ingredient feeder 130 may be located inside the housing 105 and inaccessible to the general public for safety, hygiene, and/or other considerations. As another example, the control 110 may be located inside the housing 105, making it inaccessible to the general public to prevent damage from environmental disturbances (e.g., spills, physical impacts) and to ensure reliable operation. The control 110 may interface with a user via a user interface (e.g., a touch screen) installed on the housing 105. There may be multiple compartments within the housing 105, each with different access-control mechanisms. For example, the housing 105 may include compartment 1 and compartment 2; access to compartment 1 may be lock or password protected, while access to compartment 2 may be granted upon request or combined with one or more other criteria. The ingredient feeder 130 is located within compartment 1 and is accessible only to authorized users (e.g., authorized staff of a restaurant or office). In contrast, the mixer 150 is accessible upon request, such as when a user requests to replace a stirrer suitable for preparing a selected beverage. In some embodiments, there may be multiple compartments within the housing 105 to achieve the desired separation between different components of the system 100. Examples of separation types include fluid separation, thermal separation, and physical separation for various considerations such as convenient cleaning, preventing cross-contamination, enhancing safety, ensuring proper insulation, and optimizing component performance. These separations may help maintain the integrity and efficiency of the system 100. In some embodiments, the housing 105 of the system 100 may be made from suitable materials such as stainless steel, aluminum, high-density polyethylene (HDPE), polycarbonate, etc. These materials are chosen for their durability, ease of cleaning, and resistance to corrosion. The system 100 may be placed in various locations, including a restaurant, a break room in an office, or a shopping mall, allowing it to meet the demands of different environments. Components of the system 100 may be arranged within or in a vicinity of the housing 105 based on one or more considerations including the vertical positioning for optimal fluid flow, the proximity for efficient operation and maintenance, potential system expansion, ease of access for cleaning and maintenance (e.g., refilling ingredients, cleaning solutions, etc.), or the like, or a combination thereof.

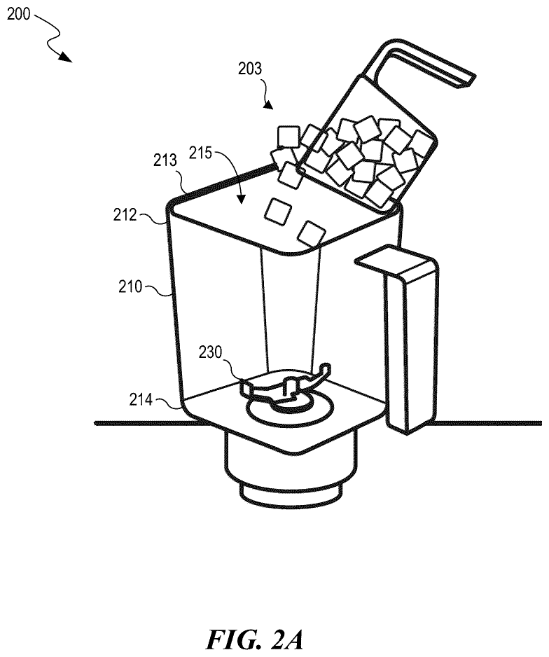

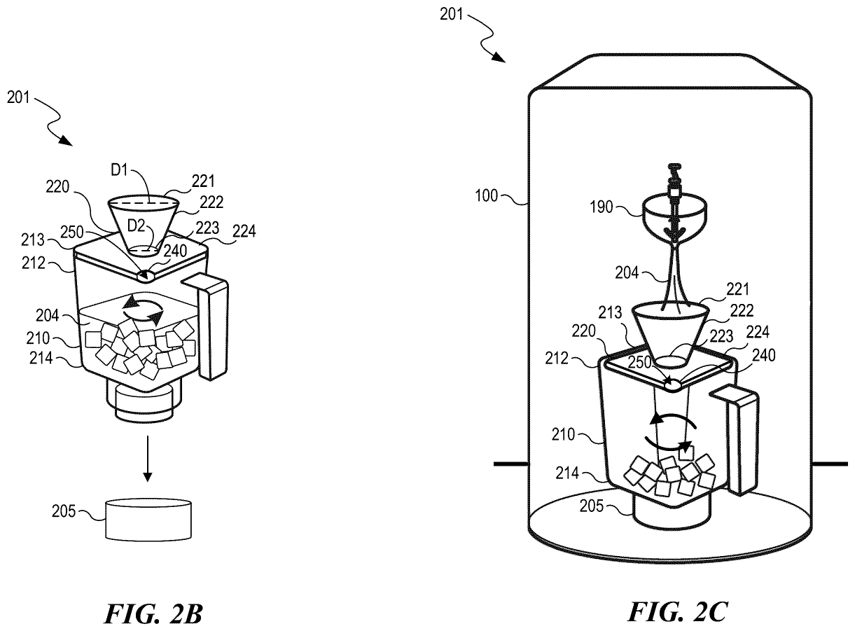

In some embodiments, system 100 includes (e.g., is integrated with) a blending module (not pictured, described further with reference to FIGS. 2A-2C). The blending module is configured to blend (e.g., mix, purée, emulsify) the contents of a cup (e.g., a blender cup). The contents of the cup can include beverage ingredients dispensed from the mixing chamber 190, beverage ingredients added manually (e.g., by hand), and/or ice. In some embodiments, the blending module is comprised of a base that houses a motor configured to rotate one or more blending components (e.g., blades) of a cup mounted to the base. When rotated by the motor, the blending components are configured to blend the contents of the cup. In some embodiments, the blending module is controlled via control 110, as described herein.

### B. Specific Examples of an Iced Blender Cup System in Accordance With Embodiments of the Present Technology

FIG. 2A illustrates a blender cup device 200 in accordance with some embodiments of the present technology. FIGS. 2B and 2C illustrate an iced blender cup system 201 for use with the blender cup device 200 of FIG. 2A. In some embodiments, the system 201 is generally similar/identical to the beverage system 100 described with reference to FIG. 1.

Referring to FIGS. 2A-2C together, in the present embodiments, the blender cup device 200 includes a chamber 210, a lid 220, and a blending component 230. The chamber 210 is configured to receive one or more measurements of ice 203 and one or more volumes of liquid beverage ingredient 204. In some embodiments, the chamber 210 is configured to receive one or more measurements of dry beverage ingredient. In some embodiments, the system 201 includes providing the ice and/or beverage ingredients (liquid and dry) through an automated dispensing process (e.g., via a dispensing machine such as the beverage system 100 described in FIG. 1, via robot, and/or other automatic dispensing mechanisms). In some embodiments, the ice and/or beverage ingredients are provided manually by a user (e.g., by hand pouring/placing into the cup device 200). In some embodiments, once the blender cup 200 contains the desired volume/measurement of beverage ingredient 204 and ice 203, the lid 220 is coupled to the chamber 210, and a blending module 205 blends the contents of the cup 200. In some embodiments, the blending module 205 is a stand-alone component (as shown in FIG. 2B). In some embodiments, the blending module 205 is integrated into a beverage dispensing machine (e.g., beverage system 100 of FIG. 1).

The chamber is comprised of an upper section 212 with a rim 213, and a lower section 214 opposite the upper section. The shape of the rim 213 defines an opening 215 of the chamber 210, through which food and beverage materials (e.g., ice, beverage ingredients, cleaning fluid, etc.) are deposited in the chamber 210. For example, the rim 213 can be approximately quadrilateral in shape (e.g., approximately a square, rhombus, etc.). The blending component 230 is integrated with the lower section 214 of the chamber 210. The blending component 230 is configured to blend (e.g., mix, emulsify, puree) the contents of the chamber 210 (e.g., via motor action of a blending module). In some embodiments, the blending component 230 is comprised of one or more blades. In some embodiments, the blending component 230 is a separate component from the cup device 200 (i.e., not integrated with the lower section 214 of the chamber 210, such as a detachable blade).

The lid 220 includes a funnel 222 integrated with a base 224. The lid 220 is configured to couple with the upper section 212 and/or rim 213 of the chamber 210. In some embodiments, the lid 220 is configured to form a seal along the portions of the lid 220 that are in contact with the chamber 210 when the lid 220 is coupled to the chamber 210.

The funnel 222 is generally conical in shape, with an inlet 221 and an outlet 223 opposite the inlet 221. The inlet 221 is configured to have a diameter D1 and the outlet 223 is configured to have a diameter D2, such that inlet diameter D1 is greater than outlet diameter D2. This helps direct beverage ingredients received at the inlet 221 to pass into the chamber 210 via the outlet 223 while mitigating/preventing beverage ingredients and ice from exiting the chamber 210 through the funnel 222 during blending operations.

The base 224 is configured to be approximately complementary in shape to the rim 213 of the chamber 210, to assist in forming a seal when the lid 220 is coupled to the chamber 210. The base includes one or more indentations 240 (e.g., grooves, notches, openings, recesses) that extend inward from (e.g., away from) the edge of the base 224 toward the center point of the base. Each indentation 240 is configured to partially define an opening 250 of the cup device 200 when the lid 220 is coupled to the upper section 212 of the chamber 210. The indentations 240 are configured such that the openings 250 are narrow (e.g., small) enough so as prevent ice and/or beverage ingredients from exiting the chamber 210 during blending operations, but wide (e.g., large) enough to facilitate the controlled flow of the blended mixture out of the chamber 210 while pouring. In some embodiments, one or more of the indentations 240 are semi-circular in shape. In some embodiments, one or more of the indentations 240 are angular in shape (e.g., triangular, V-shaped, etc.). Depending on the amount and shape of beverage ingredients and ice contained in the chamber 210, it will be appreciated that a variety of indentation 240 shapes may be desirable that best prevent chamber 210 contents from exiting during blending while still facilitating smooth pouring post-blending.

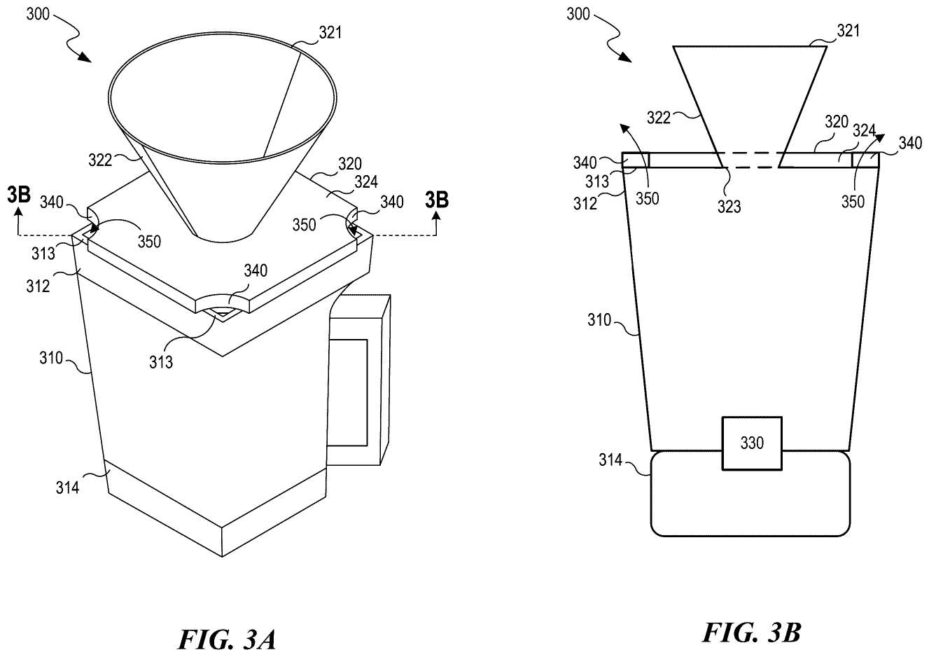

FIG. 3A is a perspective view of a blender cup device 300 in accordance with some embodiments of the present technology. FIG. 3B is a cross-sectional schematic of the blender cup device 300 of FIG. 3A. In some embodiments, the blender cup device 300 includes features that are generally similar/identical to blender cup device 200 of FIGS. 2A-2C. Accordingly, similar reference numbers refer to similar components.

Referring to FIGS. 3A and 3B together, in the present embodiments, the blender cup device 300 is comprised of a chamber 310 including an upper section 312 and a lower section 314. The upper section 312 includes a rim 313 that defines an opening of the chamber 310. A lid 320 is configured to fit over the opening of the chamber 310 when coupled to the upper section 312 of the chamber 310. The lid 320 is comprised of a funnel 322 and a base 324. The lower section 314 includes a blending component 330.

The funnel 322 includes an outlet 323 and an inlet 321 and is configured to direct and/or guide beverage ingredient dispensed, for example, from a beverage dispensing system (e.g., the beverage system 100 of FIG. 1) into the chamber 310. Both the outlet 323 and the inlet 321 of the funnel 322 are positioned above the rim 313 of the chamber 310 when the lid 320 is coupled to the upper section 312 of the chamber 310. This arrangement can accommodate a variety of beverage dispensing machines (e.g., beverage system 100) with dispensing openings (e.g., beverage ingredient dispensing nozzles) of a certain height above the blender cup 300, ensuring that liquid beverage ingredient is directed into the chamber 310 from a higher position. This helps control the flow of beverage ingredient into the funnel 322 and reduces the likelihood of spillage. This configuration also minimizes that amount of space in the chamber 310 taken up by the funnel 322, allowing more room for blended beverage/ingredients and/or ice, as well as simplifies cleaning/rinsing of the chamber 310 by removing flow obstacles in the chamber 310 interior.

The base 324 and the rim 313 are approximately quadrilateral (e.g., approximately square) in shape. In some embodiments, each of the one or more indentations 340 of the base 324 is positioned proximate to one or more corners of the rim 313. In some embodiments, one or more of the indentations 340 is positioned distant from the one or more corners (e.g., part-way along an approximately straight edge of the base 324 between two corners of the rim 313). In the present example, four indentations 340 are shown, though more or less are contemplated (e.g., one, two, three, five, six, etc.). The indentations 340 are approximately semi-circular in shape, with the curve of the semi-circle curving toward a center point of the base 324 and away from the edge of the base 324. Each of the indentations 340 are configured to at least partially define an opening 350 through which blended beverage (e.g., liquid and/or dry beverage ingredients blended with ice) contained in the chamber 310 can be poured into, for example, an individual serving cup, while the lid 320 remains coupled to the chamber 310. In some embodiments the indentations 340 are further configured to allow for cleaning fluid (e.g., water, cleaning solution, etc.) to be poured/drained out of the chamber 310 after cleaning/rinsing while the lid 320 remains coupled to the chamber 310.

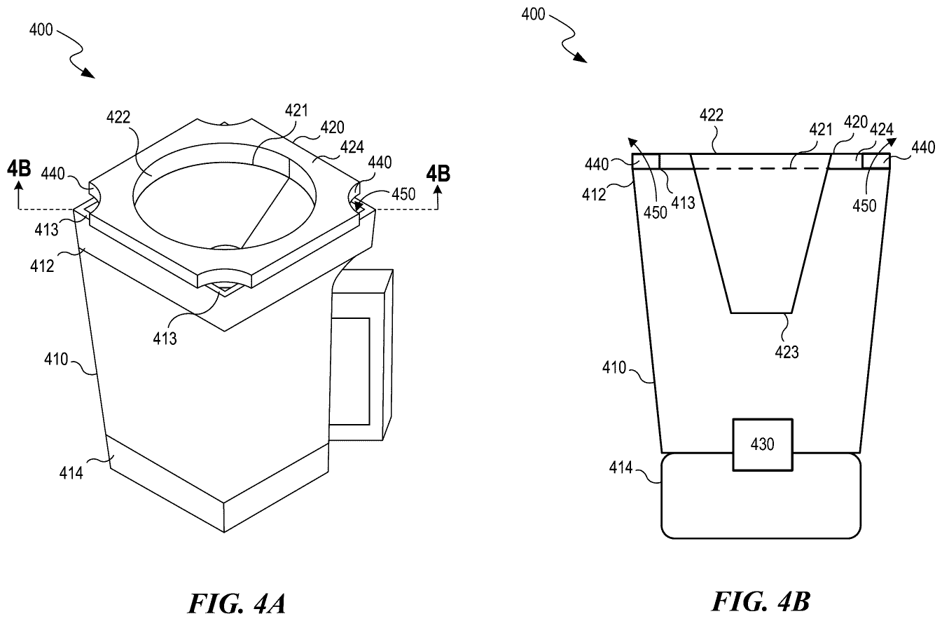

FIG. 4A is a perspective view of a blender cup device 400 in accordance with some embodiments of the present technology. FIG. 4B is a cross-sectional schematic of the blender cup device 400 of FIG. 4A. In some embodiments, the blender cup device 400 includes features that are generally similar/identical to blender cup device 200 of FIGS. 2A-2C, and/or the blender cup device 300 of FIGS. 3A-3B. Accordingly, similar reference numbers refer to similar components.

Referring to FIGS. 4A and 4B together, in the present embodiments, blender cup device 400 is similarly configured as blender cup device 300, with one exception being the arrangement of the lid 420 and funnel 422. In some embodiments, the outlet 423 of the funnel 422 is positioned below the rim 413 of the chamber 410, while the inlet 421 of the funnel 422 is approximately flush with the plane of the rim 413 when the lid 420 is coupled to the upper section 412 of the chamber 410. This configuration may be advantageous in accommodating a number blending machine and/or dispensing machine systems (e.g., beverage system 100 of FIG. 1), while also maintaining an economical, compact shape.

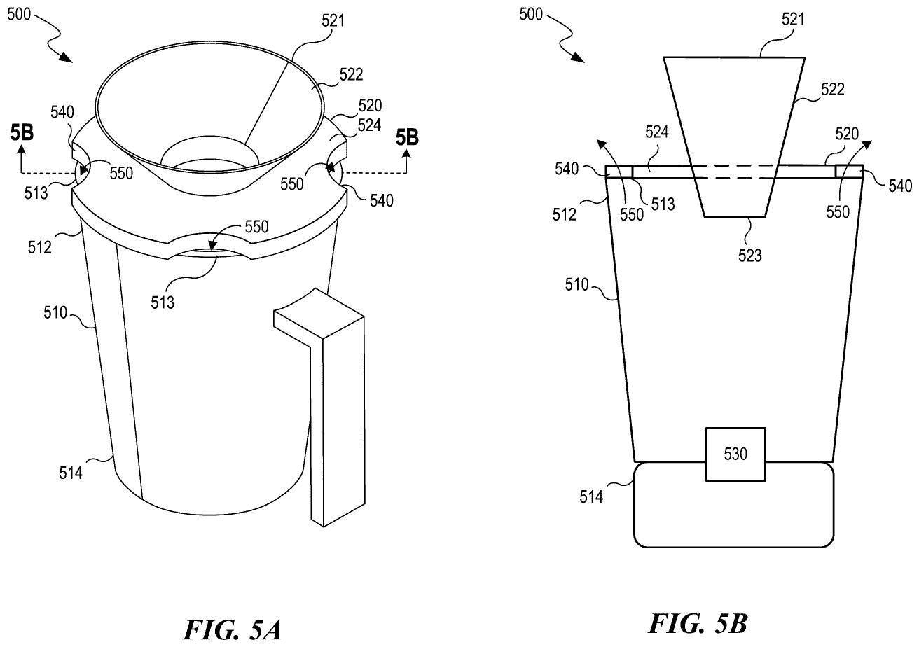

FIG. 5A is a perspective view of a blender cup device 500 in accordance with some embodiments of the present technology. FIG. 5B is a cross-sectional schematic of the blender cup device 500 of FIG. 5A. In some embodiments, the blender cup device 500 includes features that are generally similar/identical to blender cup device 200 of FIGS. 2A-2C, blender cup device 300 of FIGS. 3A-3B, and/or blender cup device 400 of FIGS. 4A-4B. Accordingly, similar reference numbers refer to similar components.

Referring to FIGS. 5A and 5B together, in the present embodiments, blender cup device 500 is similarly configured as blender cup devices 300 and 400, with one exception being the outlet 523 of the funnel 522 is positioned below the rim 513 of the chamber 510, while the inlet 521 of the funnel 522 is situated above the rim 513 of the chamber 510 when the lid 520 is coupled to the upper section 512 of the chamber 510. Additionally, the rim 513 is approximately circular in shape, as is the base 524 in order to complement the shape of the rim 513. The base 524 has four indentations 540 that curve inward with respect to a center point of the base 524, and spaced approximately equally around the edge of the base 524. Thus, the base 524 has four rounded edges configured to form at least a partial seal with the rim 513 and/or upper section 512, and four rounded indentations 540 curving inward, each of a generally semicircular shape.

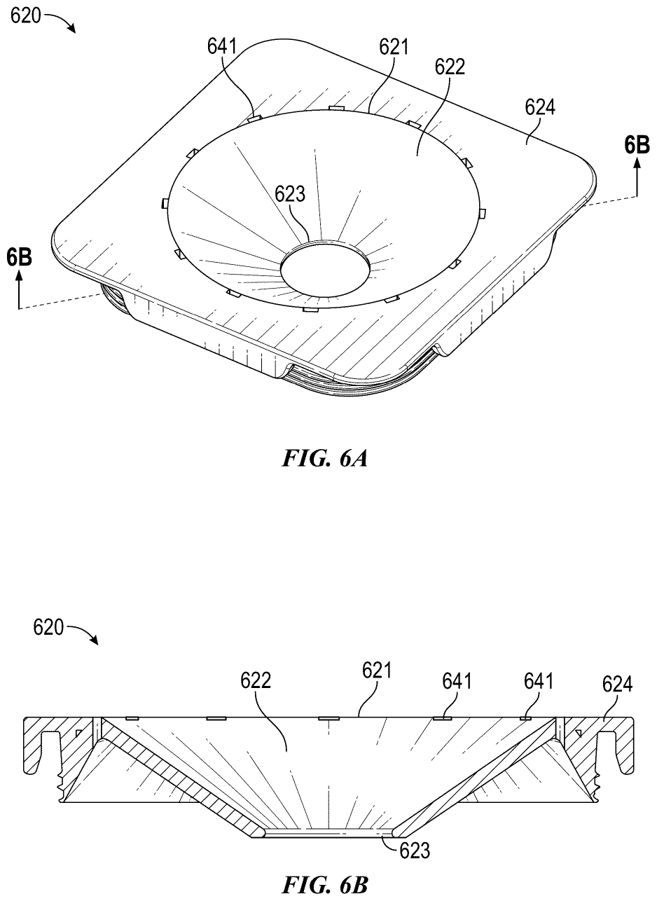

FIG. 6A is a perspective view of a blender cup lid 620 in accordance with some embodiments of the present technology. FIG. 6B is a cross-sectional schematic from line 6B-6B of the blender cup lid 620 of FIG. 6A. In some embodiments, the lid 620 includes features that are generally similar/identical to lids 220, 320, 420, and 520 of FIGS. 2A-5B. Accordingly, similar reference numbers refer to similar components.

Referring to FIGS. 6A and 6B together, in the present embodiments, lid 620 includes a funnel 622 with an inlet 621 positioned slightly above a chamber rim (not pictured) and an outlet 623 positioned below the rim (when the lid 620 is coupled to the upper section of the chamber, not pictured). The funnel 622 includes one or more openings 641 positioned around the edge (i.e., rim) of the inlet 621. In some embodiments, the openings 641 are evenly spaced around the edge of the inlet. The openings are configured to allow fluid (e.g., cleaning fluid/water) to drain from the chamber of the cup through the openings 641. Although not shown, in some embodiments, lid 620 further includes one or more indentations such as those described in FIGS. 2A-5B.

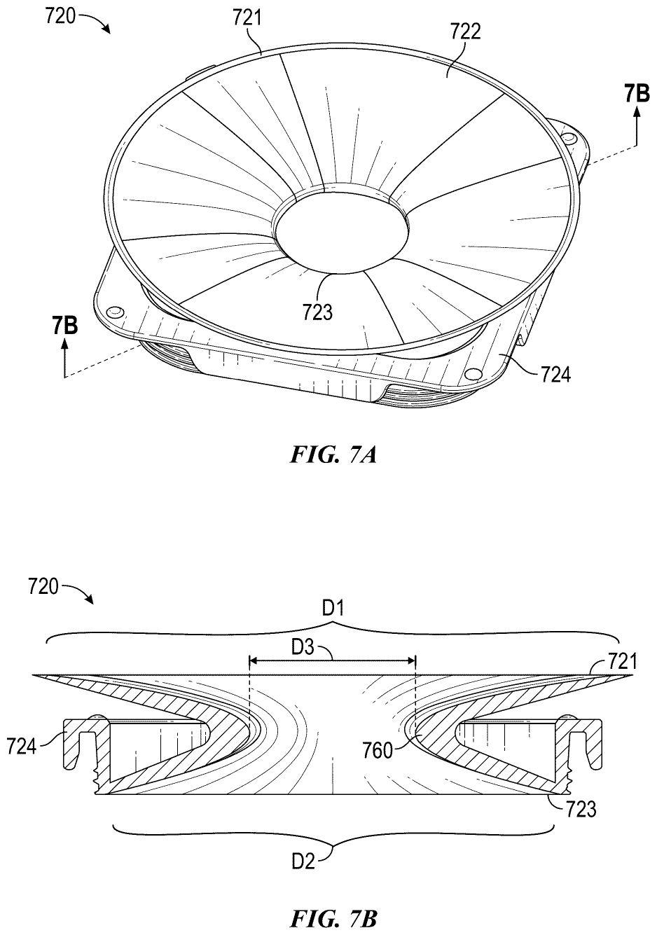

FIG. 7A is a perspective view of a blender cup lid 720 in accordance with some embodiments of the present technology. FIG. 7B is a cross-sectional schematic from line 7B-7B of the blender cup lid 720 of FIG. 7A. In some embodiments, the lid 720 includes features that are generally similar/identical to lids 220, 320, 420, 520, and 620 of FIGS. 2A-6B. Accordingly, similar reference numbers refer to similar components.

Referring to FIGS. 7A and 7B together, in the present embodiments, lid 720 includes a funnel 722 with an inlet 721 positioned above a chamber rim (not pictured) and an outlet 723 positioned generally flush with the chamber rim when the lid 720 is coupled to the upper section of the chamber. The funnel 722 is generally hour-glass shaped, with a narrow section 760 positioned part-way between the outlet 723 and the inlet 721. That is, the narrow section 760 is configured to have a smaller diameter D3 than either the outlet diameter D2 or the inlet diameter D1. This configuration helps mitigate ice and/or beverage ingredients from escaping the chamber without taking up space in the chamber. Although not shown, in some embodiments, lid 720 further includes one or more indentations such as those described in FIGS. 2A-5B.

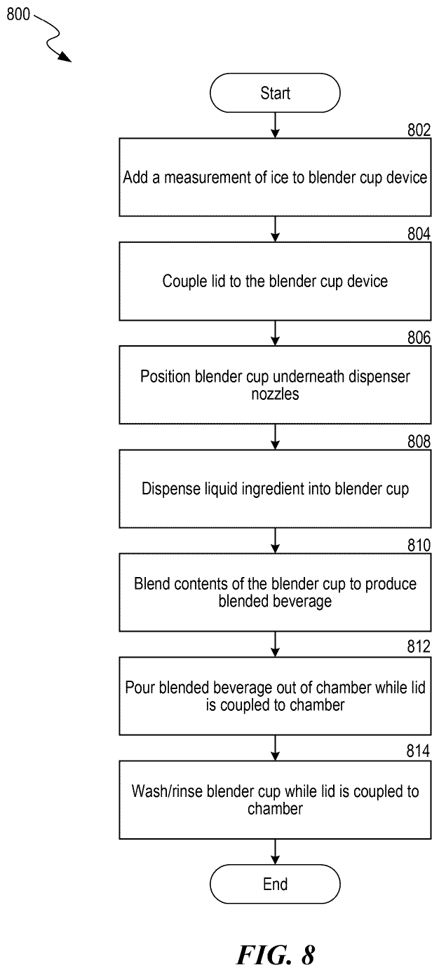

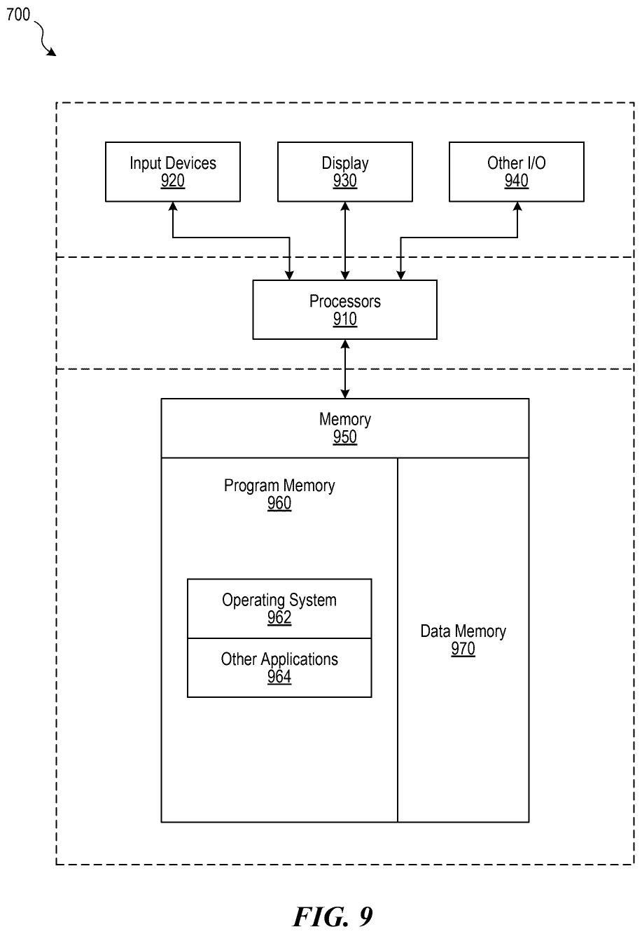

FIG. 8 is a flowchart illustrating a method 800 of preparing an iced blended beverage in accordance with some embodiments of the present technology. In some embodiments, one or more steps of method 800 are implemented via a beverage dispensing/beverage ingredient dispensing machine (e.g., beverage system 100 of FIG. 1) and a blender cup (e.g., any of blending/blender cup devices 200, 300, 400, and 500 disclosed herein). In some embodiments, one or more steps of method 800 are implemented via a computer and/or network (e.g., the computer systems discussed with reference to FIGS. 9-9).

In step 802, a measurement of ice is added to a blender cup device, such as blender cup device 200 of FIGS. 2A-2C. In some embodiments, the ice is added to a chamber of the cup device configured to receive ice and other beverage ingredients. The chamber includes an upper section with a rim, and a lower section opposite the upper section.

In step 804, a lid is coupled to the cup device. In some embodiments, the lid and cup device are coupled such that a seal is formed between the rim and the lid along the edges of the lid that are in contact with the rim. In some embodiments, the lid includes a funnel integrated with a base. The funnel is configured to guide beverage ingredients into the chamber of the cup device while the lid is coupled to the cup device. In some embodiments, the funnel is configured such that both the outlet and inlet of the funnel are positioned above a plane of the rim. That is, no part of the funnel extends downward into the chamber space of the cup device. In some embodiments, the funnel is configured such that the inlet is positioned above a plane of the rim, while the outlet is positioned below the plane of the rim. In some embodiments, the funnel is configured such that the outlet is positioned below the plane of the rim and the inlet is approximately flush with the plane of the rim.

In some embodiments, the base is configured to be approximately complimentary in shape to the rim of the chamber. In some embodiments, the base includes one or more indentations (e.g., recesses, grooves, notches) extending inward from the edge of the base toward the center point of the base. Each of the indentations at least partially defines an opening of the cup device through which blended (e.g., mixed) beverage can be poured out of the chamber.

At step 806, the blender cup device is positioned beneath one or more beverage ingredient dispensing nozzles. In some embodiments the liquid beverage ingredient dispensing nozzles (also referred to as openings) are components of a beverage dispensing (and/or mixing) system (e.g., beverage system 100 of FIG. 1). In some embodiments, the beverage dispensing system includes a blending mechanism (e.g., a blending motor) configured to interface with a blending component (e.g., blades) integrated into the lower section of the blender cup chamber.

At step 808, beverage ingredients are dispensed into the blender cup. The beverage ingredients are received by the inlet of the funnel of the lid and guided into the chamber of the blender cup via the outlet of the funnel. At step 810, the contents of the blender cup (e.g., the measurement of ice, the liquid and/or dry beverage ingredients dispensed by the beverage system, etc.) are blended via the blending component of the lower section of the chamber to produce a volume of blended beverage. At step 812, the blended beverage is poured out of the chamber (e.g., into an individual serving cup) via one or more of the openings at least partially defined by the indentations in the base of the lid while the lid remains coupled to the chamber.

In step 814, in some embodiments, the blender cup is washed and/or rinsed while the lid remains coupled to the chamber. For example, a volume of cleaning fluid (e.g., water, cleaning solution, etc.) is dispensed into the blender cup via the beverage system. The cleaning fluid is received by the inlet of the funnel of the lid and guided into the chamber via the outlet of the funnel. The chamber is cleaned with the cleaning fluid to produce, for example, waste fluid (e.g., dirty water) while the lid remains coupled to the chamber. In some embodiments, the waste fluid is drained from the chamber via the openings partially defined by the indentations in the base of the lid.

### C. Computer Systems

Several implementations are discussed below in more detail in reference to the figures. FIG. 9 is a block diagram illustrating an overview of devices on which some implementations of the disclosed technology can operate. The devices can include hardware components of a device 900 that execute customized queries created from user selections of query elements, that are based on meta-data from data set registrations. Device 900 can include one or more input devices 920 that provide input to the Processor(s) 910 (e.g., CPU(s), GPU(s), HPU(s), etc.), notifying it of actions. The actions can be mediated by a hardware controller or control circuit that interprets the signals received from the input device and communicates the information to the processors 910 using a communication protocol. Input devices 920 include, for example, a mouse, a keyboard, a touchscreen, an infrared sensor, a touchpad, a wearable input device, a camera-or image-based input device, a microphone, or other user input devices.

Processors 910 can be a single processing unit or multiple processing units in a device or distributed across multiple devices. Processors 910 can be coupled to other hardware devices, for example, with the use of a bus, such as a peripheral component interconnect (PCI) bus or small computer system interface (SCSI) bus. The processors 910 can communicate with a hardware controller or control circuit for devices, such as for a display 930. Display 930 can be used to display text and graphics. In some implementations, display 930 provides graphical and textual visual feedback to a user. In some implementations, display 930 includes the input device as part of the display, such as when the input device is a touchscreen or is equipped with an eye direction monitoring system. In some implementations, the display is separate from the input device. Examples of display devices include: a liquid crystal display (LCD) screen, a light emitting diode (LED) screen, a projected, holographic, or augmented reality display (such as a heads-up display device or a head-mounted device), and so on. Other input/output (I/O) devices 940 can also be coupled to the processor, such as a network card, video card, audio card, USB, firewire or other external device, camera, printer, speakers, compact disc read-only memory (CD-ROM) drive, digital versatile disc (DVD) drive, disk drive, or Blu-Ray device.

In some implementations, the device 900 also includes a communication device capable of communicating wirelessly or wire-based with a network node. The communication device can communicate with another device or a server through a network using, for example, transmission control protocol/internet protocol (TCP/IP) protocols. Device 900 can utilize the communication device to distribute operations across multiple network devices.

The processors 910 can have access to a memory 950 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 950 can include program memory 960 that stores programs and software, such as an operating system 962 and other application programs 964. Memory 950 can also include data memory 970, e.g., table data, column data, value filter data, user interface data, database element data, selection data, root table data, code snippet data, join query data, query template data, connection data, configuration data, settings, user options or preferences, etc., which can be provided to the program memory 960 or any element of the device 900.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

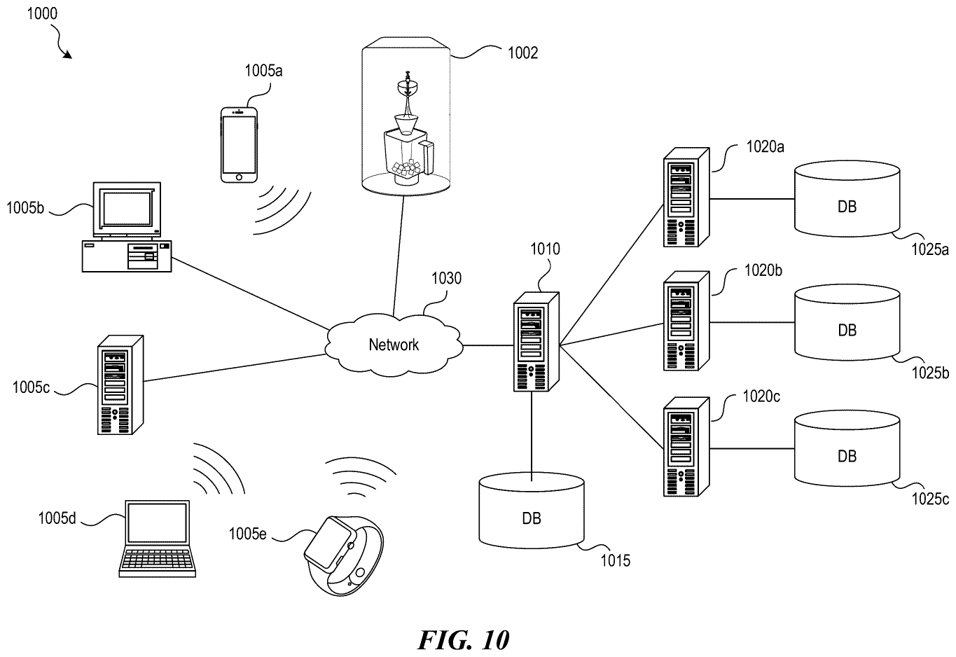

FIG. 10 is a block diagram illustrating an overview of an environment 1000 in which some implementations of the disclosed technology can operate. Environment 1000 can include one or more client computing devices 805a-e (collectively referred to as “client computing devices 1005”) and a beverage system 1002. Client computing devices 1005 and the beverage system 1002 (e.g., system 100 described elsewhere in the present document) can operate in a networked environment using logical connections through network 1030 to one or more remote computers, such as a server computing device.

In some implementations, server 1010 can be an edge server which receives client requests and coordinates fulfillment of those requests through other servers, such as servers 820a-c. Server computing devices 1010 and 1020 can include computing systems, such as device 900. Though each server computing device 1010 and 1020 is displayed logically as a single server, server computing devices can each be a distributed computing environment encompassing multiple computing devices located at the same or at geographically disparate physical locations. In some implementations, each server 1020 corresponds to a group of servers.

Client computing devices 1005 and server computing devices 1010 and 1020 can each act as a server or client to other server/client devices. Server 1010 can connect to a database 1015. Servers 820a-c can each connect to a corresponding database 825a-c. As discussed above, each server 1020 can correspond to a group of servers, and each of these servers can share a database or can have their own database. Databases 1015 and 1025 can warehouse (e.g., store) information such as table data, column data, value filter data, user interface data, database element data, selection data, root table data, code snippet data, join query data, query template data, connection data. Though databases 1015 and 1025 are displayed logically as single units, databases 1015 and 1025 can each be a distributed computing environment encompassing multiple computing devices, can be located within their corresponding server, or can be located at the same or at geographically disparate physical locations.

Network 1030 can be a local area network (LAN) or a wide area network (WAN), but can also be other wired or wireless networks. Network 1030 may be the Internet, a mobile phone network, a mobile voice or data network (e.g., a 5G or long term evolution (LTE) network), a cable network, a public switched telephone network, a short-range wireless communication network (e.g., Bluetooth or Near Field Communications (NFC)), or some other public or private network. Client computing devices 1005 can be connected to network 1030 through a wired or wireless network interface, such as a satellite path, a fiber-optic path, a cable path, a path that supports internet communications (e.g., internet protocol television (IPTV)), free-space connections (e.g., for broadcast or other wireless signals), etc. While the connections between server 1010 and servers 1020 are shown as separate connections, these connections can be any kind of local, wide area, wired, or wireless network, including network 1030 or a separate public or private network. As described in further detail herein, the client computing devices 1005 and the beverage system 1002 can operate according to an edge computing protocol (e.g., an edge computing decryption protocol).

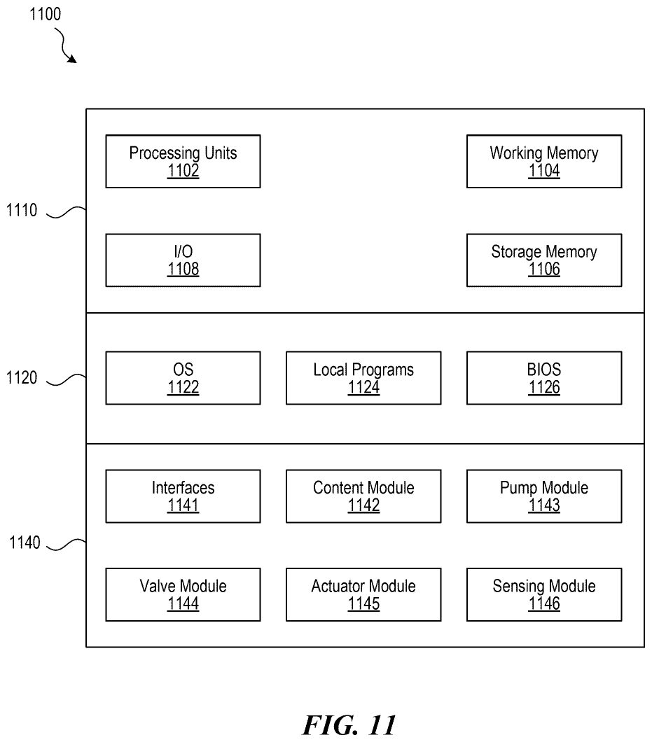

FIG. 11 is a block diagram illustrating components 1100 which, in some implementations, can be used in a system employing the disclosed technology. In some implementations, some or all of the components 1100 can be included in the beverage system 1002 (e.g., the system 100). The components 1100 include hardware 1110, general software 1120, and specialized components 1140. The components 1100 may correspond to the control 110 as illustrated in FIG. 1.

As discussed above, a system implementing the disclosed technology can use various hardware 1110 including processing units 1102 (e.g., CPUs, GPUs, accelerated processing units (APUs), etc.), working memory 1104, storage memory 1106 (local storage or as an interface to remote storage, such as storage 1015 or 1025), and input and output devices 1108. In various implementations, storage memory 1106 can be one or more of: local devices, interfaces to remote storage devices, or combinations thereof. For example, storage memory 1106 can be a set of one or more hard drives (e.g., a redundant array of independent disks (RAID)) accessible through a system bus or can be a cloud storage provider or other network storage accessible via one or more communications networks (e.g., a network accessible storage (NAS) device, such as storage 1015 or storage provided through another server 1020). Components 1100 can include a machine-readable storage medium having machine executable instructions stored thereon. Components 1100 can be implemented in a client computing device such as client computing devices 1005, on the beverage system 1002, or on a server computing device, such as server computing device 1010 or 1020.

General software 1120 can include various applications including an operating system (OS) 1122, local programs 1124, and a basic input output system (BIOS) 1126.

Specialized components 1140 can be subcomponents of a general software application 1120, such as local programs 1124. Specialized components 1140 can include content module 1142, pump module 1143, valve module 1144, actuator module 1145, and sensing module 1146, and components which can be used for providing user interfaces, transferring data, and controlling the specialized components, such as interfaces 1141. In some implementations, components 1100 can be in a computing system that is distributed across multiple computing devices or can be an interface to a server-based application executing one or more of specialized components 1140.

In some implementations, the content module 1142 may be configured to manage inventory of one or more fluids, ingredients, and/or cleaning solutions stored in or otherwise accessible to the beverage system 1002 and select which content is to be delivered based on an operation to be performed including, e.g., a beverage to be prepared, a cleaning process to be performed, etc. For example, the beverage system 1002 can include ingredient sources or containers containing twenty different ingredients, and upon receiving a signal or indication that a specific beverage is desired whose preparation involves two of the twenty ingredients available, the content module 1142 can selectively provide those two ingredients. As another example, the content module 1142 may monitor inventory, based on which the beverage system 1002 may take actions accordingly. For instance, the content module 1142 may track the remaining amount of an ingredient, its shelf life, and/or demand based on historical data (e.g., over the past day, week, month, similar season, etc.). Based on the information acquired by the content module 1142, the beverage system 1002 may provide a reminder for restocking, automatically place an order for restocking, and/or adjust the beverage options available for user selection. For example, the beverage system 1002 may remove an option from the menu presented to a user if a needed ingredient is low or out of stock, and/or add the beverage option back to the menu when the ingredient is restocked in the beverage system 1002.

In some implementations, the pump module 1143 may be configured to manage the driving and/or dispensing of liquid-based and/or gas content in the beverage system 1002. For example, the pump module 1143 may be configured to manage the driving of content received from, e.g., a source or container, through the beverage system 1002 and dispensing it via one or more openings. For example, the pump module 1143 can set the appropriate flow rate, dispensing quantity or volume, pressure, frequency, flow direction, etc., depending on, for example, a desired operation (e.g., a cleaning operation, an operation to produce a selected beverage of a desired temperature) and/or characteristics (e.g., viscosity of the individual ingredient(s)/cleaning solution(s) involved). In some embodiments, the pump module 1143 can communicate with other modules, such as the valve module 1144 and/or the sensing module 1146, to coordinate dispensing of content with one or more desired parameters.

In some implementations, the valve module 1144 may be configured to manage the flow of liquid-based and/or gas content in the beverage system 1002. For example, the valve module 1144 can set the appropriate flow rate, dispensing quantity or volume, pressure, frequency, flow direction, etc., depending on, for example, a desired operation (e.g., a cleaning operation, an operation to produce a selected beverage of a desired temperature). In some embodiments, the valve module 1144 can communicate with other modules, such as the pump module 1143 and/or the sensing module 1146, to coordinate dispensing of content with one or more desired parameters.

In some implementations, the actuator module 1145 may be configured to manage the operation of an actuator, motor, pulse generator, etc., in the beverage system 1002. For example, the actuator module 1145 can set the timing, duration, power, etc., of an actuator or motor, depending on, e.g., a desired operation (e.g., a cleaning operation, a mixing operation, a dispensing operation, a drainage operation). In some embodiments, the actuator module 1145 can communicate with other modules, such as the pump module 1143 and/or the valve module 1144, to coordinate dispensing and mixing of content with one or more desired parameters.

In some implementations, the sensing module 1146 may be configured to manage the operation relating to a sensor or sensing circuit in the beverage system 1002. For example, the sensing module 1146 may manage the operation of a heating element based on temperature of content (e.g., water, a mixture including water) in or exiting a fluid channel, in the mixing chamber 190, etc. The sensing module 1146 may receive information acquired by a sensor or sensing circuit within or coupled to the beverage system 1002, e.g., a temperature sensor or sensing circuit, a pressure sensor or sensing circuit, etc.

Although depicted as separate components, specialized components 1140 may be logical or other nonphysical differentiations of functions and/or may be submodules or code-blocks of one or more applications. The components 1140 may include or correspond to various controller or control circuits described elsewhere in the present document. Those skilled in the art will appreciate that the components described herein may be altered in a variety of ways.

### D. Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. An iced beverage blending system comprising:
a cup device including:
a chamber including an upper section with a rim, and a lower section opposite the upper section, the chamber configured to receive a volume of at least one liquid beverage ingredient and a measurement of ice;
a lid configured to couple to the upper section, the lid including:
a funnel including an inlet and an outlet, the funnel configured to direct liquid beverage ingredient received at the inlet to the chamber via the outlet; and
a base configured to be approximately complimentary in shape to the rim of the chamber; and
a blending component integrated with the chamber, the blending component configured to blend ice with beverage ingredients contained in the chamber;
a processor; and
a memory including instructions that, when executed by the processor, cause the cup device to:
receive, via the funnel of the lid, the volume of at least one liquid beverage ingredient in the chamber; and
blend, via the blending component, the volume of at least one liquid beverage ingredient in the chamber with the measurement of ice.

2. The iced beverage blending system of claim 1, wherein the base includes one or more indentations extending inward from an edge of the base toward a center point of the base, and wherein each of the indentations is configured to partially define an opening of the cup device when the lid is coupled to the upper section.

3. The iced beverage blending system of claim 1, wherein the outlet of the funnel is positioned below the rim of the chamber and the inlet of the funnel is positioned above the rim of the chamber when the lid is coupled to the upper section of the chamber.

4. The iced beverage blending system of claim 1, wherein both the outlet and inlet of the funnel are positioned above the rim of the chamber when the lid is coupled to the upper section of the chamber.

5. The iced beverage blending system of claim 1, wherein the outlet of the funnel is positioned below the rim of the chamber and the inlet of the funnel is approximately flush with a plane of the rim when the lid is coupled to the upper section of the chamber.

6. The iced beverage blending system of claim 2, wherein the rim of the chamber and the base are approximately quadrilateral in shape, and wherein each of the one or more indentations of the base are positioned proximate to one or more corners of the rim.

7. The iced beverage blending system of claim 2, wherein the rim of the chamber and the base are approximately round in shape, and wherein the one or more indentations are approximately evenly distributed around the edge of the base.

8. The iced beverage blending system of claim 2, wherein each of the one or more indentations is either semi-circular in shape or angular in shape.

9. The iced beverage blending system of claim 1, wherein the chamber is further configured to receive a measurement of dry beverage ingredient, and wherein the memory further includes instructions that, when executed by the processor, cause the cup device to:
blend, via the blending component, the measurement of dry beverage ingredient with the volume of at least one liquid beverage ingredient and the measurement of ice in the chamber.

10. The iced beverage blending system of claim 1, wherein the funnel of the lid is further configured to direct a volume of cleaning fluid received at the inlet to the chamber via the outlet, and wherein the memory further includes instructions that, when executed by the processor, cause the cup device to:
receive, via the funnel of the lid, the volume of cleaning fluid in the chamber.

11. A blender cup device for use with a beverage dispenser, the device comprising:
A chamber including a rim, the chamber configured to receive a volume of at least one beverage ingredient and a measurement of ice;
a lid configured to couple to the chamber, the lid including:
a funnel configured to direct beverage ingredient received by the funnel to the chamber; and
a base configured to be approximately complimentary in shape to the rim of the chamber, the base including one or more indentations extending inward from an edge of the base toward a center point of the base, wherein each of the indentations is configured to partially define an opening of the cup device when the lid is coupled to the chamber; and
a blending component integrated with the chamber, the blending component configured to blend the contents of the chamber.

12. The blender cup device of claim 11, wherein the base includes one or more indentations extending inward from an edge of the base toward a center point of the base, and wherein each of the indentations is configured to partially define an opening of the cup device when the lid is coupled to the chamber.

13. The blender cup device of claim 11, wherein an outlet of the funnel is positioned below the rim of the chamber and an inlet of the funnel is positioned above the rim of the chamber when the lid is coupled to the chamber.

14. The blender cup device of claim 11, wherein both an outlet and an inlet of the funnel are positioned above the rim of the chamber when the lid is coupled to the chamber.

15. The blender cup device of claim 11, wherein an outlet of the funnel is positioned below the rim of the chamber and an inlet of the funnel is approximately flush with a plane of the rim when the lid is coupled to the chamber.

16. The blender cup device of claim 12, wherein the rim of the chamber and the base are approximately quadrilateral in shape, and wherein each of the one or more indentations of the base are positioned proximate to one or more corners of the rim.

17. The blender cup device of claim 12, wherein the rim of the chamber and the base are approximately round in shape, and wherein the one or more indentations are approximately evenly distributed around the edge of the base.

18. A method of blending an iced beverage, the method comprising:
adding a measurement of ice to a chamber of a blender cup device, the chamber of the blender cup device including an upper section with a rim, and a lower section opposite the upper section;
coupling a lid to the upper section of the chamber, the lid including a funnel and a base, the base being approximately complimentary in shape to the rim of the chamber;
dispensing a volume of at least one liquid ingredient into the chamber of the blender cup device via the funnel;
blending, via a blending component integrated with the chamber, the volume of at least one liquid ingredient with the measurement of ice to produce a blended beverage; and
pouring the blended beverage from the chamber.

19. The method of claim 18, wherein the base includes one or more indentations extending inward from an edge of the base toward a center point of the base, wherein each of the indentations partially defines an opening of the blender cup device, and wherein pouring the blended beverage from the chamber is via the openings partially defined by the indentations of the base while the lid is coupled to the chamber.

20. The method of claim 19, further comprising:
dispensing a volume of cleaning fluid into the chamber of the blender cup device via the funnel;
cleaning the chamber with the cleaning fluid to produce waste fluid while the lid is coupled to the upper section; and
draining the waste fluid from the chamber via the openings partially defined by the indentations of the base while the lid is coupled to the chamber.
